(19) United States
(12) Patent Application Publication
(10) Pub. No.: US 2008/0120369 A1
(43) Pub. Date: May 22, 2008

(54) MEDIA CENTER FOR PICTURE SHARING

(76) Inventor: Bengt Stefan GUSTAVSSON, Helsingborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/560,497

(22) Filed: Nov. 16, 2006

(51) Int. Cl. G06F 15/16; H04N 9/04; H04M 1/00

(52) U.S. Cl. 709/204; 348/222.1; 455/556.1; 348/E09.002

(57) ABSTRACT

A media center for sharing audio and/or visual (A/V) files among a plurality of mobile devices. The media center includes digital storage for storing A/V files; a wireless local or personal area network transceiver for receiving A/V files transmitted from the mobile devices and storing the received A/V files in the digital storage; and a registration section for automatically soliciting registration of mobile devices within the wireless network in order to participate in sharing A/V files.

### TECHNICAL FIELD OF THE INVENTION

The present invention relates generally to mobile communications, and more particularly to automated picture and/or other type audio/visual file sharing among mobile devices.

### DESCRIPTION OF THE RELATED ART

Since the advent of still picture cameras, video cameras, audio recorders, etc., there has been a natural desire to record special events via photography, video and the like. For example, memory making events such as weddings, graduation parties, anniversary parties, etc. are typically the subject of photographs, videos, audio recordings, etc. so that the participants may recall the many fond memories in the years to follow.

For years, it has been common practice to hire professional photographers and/or videographers to record such special events. The professional pictures and videos serve as an excellent form of remembrance. Unfortunately, sometimes such professional pictures and videos tend to capture the overall event quite well (e.g., the general happenings at a wedding reception), but fail to capture the small spontaneous events (e.g., personal interaction among guests, events occurring at a particular table at the reception, etc.).

Accordingly, it has become somewhat customary for the host of a special event to distribute disposable cameras at each table or the like. The host requests that the guests use the cameras to take pictures at the event, pictures that may capture the small spontaneous events that the professional photographer and/or videographer is not able to capture. The host typically asks that the guests return the disposable cameras at the end of the event. In this manner, the host may have the pictures developed and as a result will have photographs of even the small spontaneous events with which to remember the occasion.

While the distribution of disposable cameras does enable the host to obtain a more complete record of an event, there are still some drawbacks. For example, guests returning the cameras at the end of the event are themselves left without copies of the pictures that they've taken. Moreover, the guests are left without copies of the pictures that other guests may have taken with the other disposable cameras. Guests may attempt to arrange with the host to obtain copies of the pictures at a later date once the photographs have been developed and additional prints obtained. However, this can be very burdensome on the host, and may take several weeks or months before the host has an opportunity to respond to all the requests for copies of the pictures, particularly in the case of an event having a large number of guests.

The availability and usage of mobile phones and other type mobile devices has increased dramatically over the last ten years. It seems like virtually everyone has their own mobile phone, adults and children alike. Frequently, these mobile phones or other mobile devices have a built in camera for capturing still images as well as video. In addition, the mobile phones are suitable for recording audio.

There have been attempts in the past to harness the popularity of mobile phones and other devices having built in cameras to capture the events of a party. For example, the Sony-Ericsson MMV-200 Media Center provides a party mode in which mobile phones my upload photos to the media center. The media center in turn displays the photos on a video monitor so that the photos may be enjoyed by many.

While such an existing media center is certainly useful, there are certain limitations. For example, the media center does not include sufficient storage to store photos for an entire event. Rather, the media center includes only a small buffer. Furthermore, uploading photos from the mobile phones to the media center can be time consuming and a bit cumbersome. The user desiring to upload photos must manually initiate the upload by operating the appropriate controls on the media center and the mobile phone. In addition, the user must manually associate the mobile phone with the media center prior to initiating the upload. Still further, the user of the mobile phone is left without the photos obtained by other guests having their own mobile phone.

In view of the aforementioned shortcomings, there exists a strong need in the art for a media center which is able to store photos and/or videos for an entire event. Moreover, there exists a strong need in the art for a media center that reduces and/or eliminates the burden to a mobile device user in associating the mobile device to the media center and initiating the upload of phones and/or videos, for example. Furthermore, there exists a strong need in the art for a media center that enables the user of a mobile device to obtain easily copies of photos, videos, etc. obtained by guests other than the user.

### SUMMARY

According to the present invention, a media center is provided for sharing audio and/or visual (A/V) files among a plurality of mobile devices. The media center includes digital storage for storing A/V files; a wireless local or personal area network transceiver for receiving A/V files transmitted from the mobile devices and storing the received A/V files in the digital storage; and a registration section for automatically soliciting registration of mobile devices within the wireless network in order to participate in sharing A/V files.

In one aspect, the media center further includes an A/V output for providing an A/V output signal suitable for reproducing the A/V files stored in the digital storage.

In another aspect, the registration section is configured to transmit a beacon to the mobile devices via the wireless network transceiver indicating the availability of A/V file sharing.

In still another aspect, the registration section is further configured to register individual ones of the mobile devices responding to the beacon in order to participate in the A/V file sharing.

According to another aspect, the registration section is configured to transmit a request for registration to the mobile devices in order to participate in A/V file sharing.

In yet another aspect, the registration section is further configured to register individual ones of the mobile devices responding to the request for registration in order to participate in the A/V file sharing.

In another aspect, the media center further includes a synchronization section for, during a synchronization operation, transmitting A/V files stored in the digital storage via the wireless transceiver to a given mobile device, the transmitted A/V files including A/V files originally provided to the media center from other of the mobile devices.

According to another aspect, the synchronization section is configured to keep track of A/V files stored in the digital storage that were provided by a given mobile device, and A/V files stored in the digital storage that were provided from other of the mobile devices, and the synchronization section causes the media center to transmit to the given mobile device substantially only A/V files provided from the other of the mobile devices as a result of the synchronization operation.

With another aspect, the synchronization section determines timing of the synchronization operation based on a predefined criteria.

In another aspect, the predefined criteria is based on an ending of a predefined session for sharing A/V files.

In still another aspect, the predefined criteria is based on the media center detecting a mobile device beginning to exceed the range of the wireless network.

In yet another aspect, the predefined criteria is based on the media center receiving a request for synchronization from the given mobile device.

With another aspect, a system is provided including the above-described media center and at least one mobile device, wherein the mobile device is configured to transmit A/V files automatically to the media center.

With still another aspect, the at least one mobile device comprises a camera, and the mobile device is configured to transmit picture files automatically to the media center upon acquisition by the camera.

Also according to the present invention, a mobile device is provided for use with a media center for sharing audio and/or visual (A/V) files among a plurality of mobile devices. The media center includes digital storage for storing A/V files; and a wireless local or personal area network transceiver for receiving A/V files transmitted from the mobile device and storing the received A/V files in the digital storage. The mobile device includes an A/V capture device for capturing audio and/or visual and converting the audio and/or visual into A/V files; and the mobile device is configured to transmit picture files automatically to the media center upon acquisition by the A/V capture device.

In another aspect, the A/V capture device is a camera.

In still another aspect, the mobile device is a mobile phone.

With another aspect, the mobile device further includes a synchronization section that determines timing of a synchronization operation, in which the media center transmits A/V files stored in the digital storage via the wireless transceiver to the mobile device, the transmitted A/V files including A/V files originally provided to the media center from other of the mobile devices, based on a predefined criteria.

In another aspect, the predefined criteria is based on the mobile device detecting it is beginning to exceed the range of the wireless network.

In still another aspect, the predefined criteria is based on the mobile device receiving a request for synchronization from the media center.

According to yet another aspect of the present invention, a media center is provided for sharing audio and/or visual (A/V) files among a plurality of mobile devices. The media center includes digital storage for storing A/V files; a wireless local or personal area network transceiver for receiving A/V files transmitted from the mobile devices and storing the received A/V files in the digital storage; and a registration section comprising a near field communication (NFC) device enabling registration of mobile devices within the wireless network in order to participate in sharing A/V files.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an environmental view of a media center for audio and/or visual (A/V) file sharing among multiple mobile devices in accordance with an exemplary embodiment of the present invention;

FIG. 2 is a block diagram of the media center in accordance with the exemplary embodiment of the present invention;

FIG. 3 is a block diagram of a mobile device in accordance with the exemplary embodiment of the present invention;

FIG. 4 is a schematic diagram of a registration procedure in accordance with one embodiment of the present invention;

FIG. 5 is a schematic diagram of a registration procedure in accordance with another embodiment of the present invention;

FIG. 6 is an exemplary display of a mobile device during registration in accordance with an aspect of the present invention;

FIG. 7 is a flowchart suitable for programming operation of the mobile device for uploading files in accordance with an exemplary embodiment of the present invention;

FIG. 8 is a flowchart suitable for programming the media center for receiving files in accordance with an exemplary embodiment the present invention;

FIG. 9 is a flowchart suitable for programming the media center to reproduce shared files in accordance with an exemplary embodiment the present invention;

FIG. 10 is a flowchart suitable for programming a mobile device to initiate a synchronization operation in accordance with an exemplary embodiment of the present invention;

FIG. 11 is an exemplary display of a mobile device as part of a synchronization operation in accordance with an embodiment of the invention;

FIG. 12 is a flowchart suitable for programming a media center to respond to a synchronization operation in accordance with an exemplary embodiment of the present invention; and

FIGS. 13 and 14 are flowcharts suitable for programming a media center and mobile device, respectively, for operation as part of a media center initiated synchronization operation.

### DETAILED DESCRIPTION OF EMBODIMENTS

The present invention will now be described with reference to the drawings, in which like reference numerals are used to refer to like elements throughout.

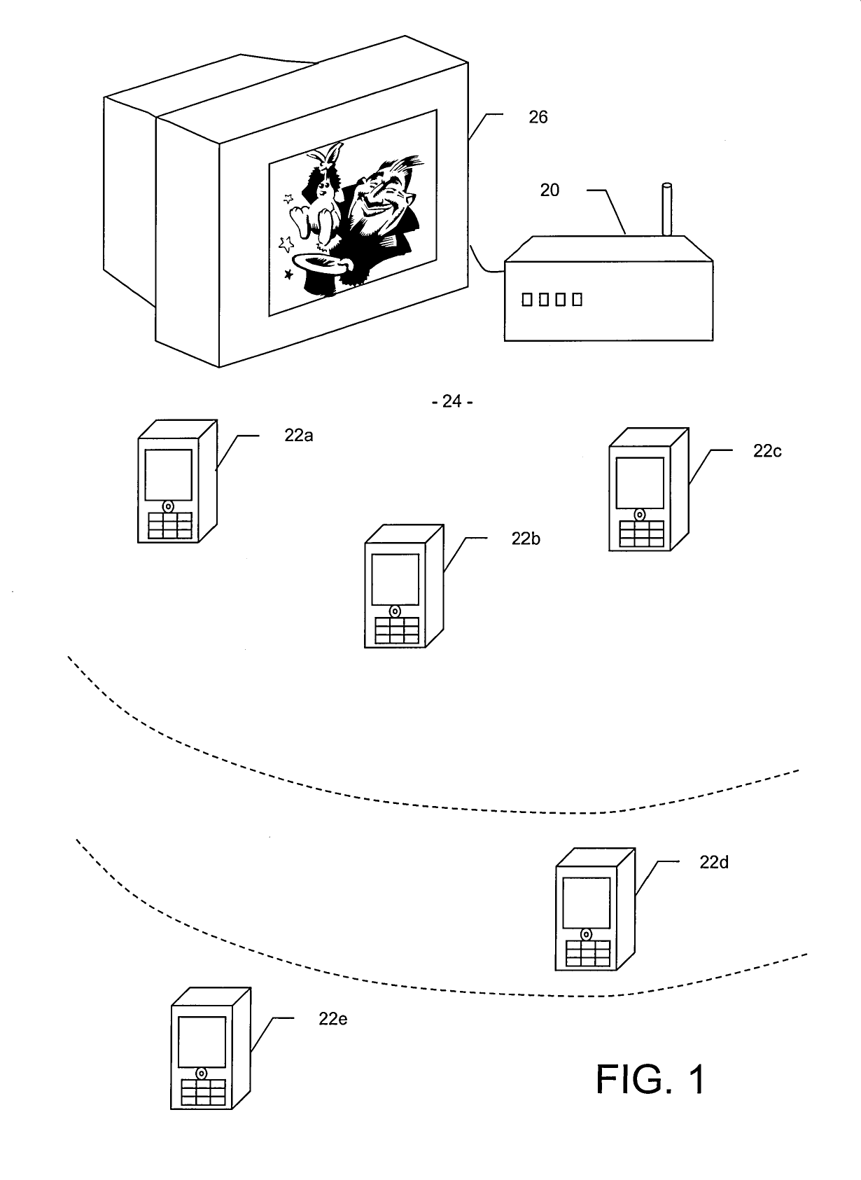

FIG. 1 illustrates a media center 20 for audio and/or visual (A/V) file sharing among multiple mobile devices 22 in accordance with an exemplary embodiment of the present invention. The media center 20 may be used in any environment 24 such as a wedding reception, anniversary party, graduation party, etc. The event may take place indoors in a party hall, banquet facility, etc., or outdoors, for example.

As will be explained in more detail below, the mobile devices 22 represent still picture cameras, video cameras, audio recorders, or the like which are capable of capturing one or more types of A/V files. In the exemplary embodiment, the mobile devices 22 may include mobile phones that incorporate a still picture camera, video camera, audio recorder, or the like. For example, guests at parties nowadays typically carry their own mobile phone having a built-in camera, etc. According to the present invention, the guests are able to take pictures, record audio snippets, etc., using their mobile phone 22. In addition, the guests are able to transmit the resultant A/V files to the media center 20 via a wireless local area network (LAN) or personal area network (PAN). The media center 20 stores the A/V files and may be configured to reproduce the A/V files during the party via a monitor 26. For example, the mobile devices 22 transmit A/V files to the media center 20 and the media center 20 in turn reproduces the A/V files as part of an automated slide show during the event so that guests may enjoy the different pictures, etc., obtained from the respective mobile devices 22.

Guests arriving at the event will have their mobile phone or other wireless equipped mobile device 22. The media center 20 is configured to solicit automatically registration of the respective mobile devices 22 so that the guests may participate in the sharing of the A/V files. When a particular mobile device 22 is within range of a wireless transceiver (not shown) included in the media center 20, as represented by mobile devices 22a, 22b and 22c, for example, the media center 20 identifies itself to the mobile device 22. The mobile device 22 then prompts the guest as to whether the guest wishes to participate in sharing files with the other guests via the media center 20. The mobile devices 22 of those guests who wish to participate are then registered with the media center 20. Thereafter, the mobile devices 22 participating in the file sharing configure themselves to transmit pictures, videos, audio snippets, etc. to the media center 20 automatically. The media center 20 in turn receives the A/V files and reproduces the files via the monitor 26, etc.

The situation will likely arise where a mobile device 22 that has been registered with the media center 20 belongs to a guest whom wishes to leave the event as represented, for example, by mobile device 22d. As will be described more fully below, the media center 20 and/or mobile device 22d detects that the mobile device 22d is leaving the wireless network. According to an aspect of the invention, the mobile device 22d prompts the guest as to whether the guest wishes to synchronize the mobile device 22d with the media center 20 so as to obtain copies of some or all of the A/V files acquired by the media center 20. In this manner, guests attending an event are able to obtain copies of photographs, video clips, etc. taken by guests other than themselves before even leaving the event. This enables the guests to enjoy memories from the event without being bothersome to the host by subsequently asking for copies of the pictures, etc. obtained during the event.

Mobile devices 22 that are outside the range of the wireless network of the media center 20 are not invited to participate in the file sharing. Thus, for example, a mobile device 22e outside the range of the media center transceiver is not solicited to participate.

Although the present invention is described herein in the context of mobile devices 22 being made up exclusively of mobile phones, it will be appreciated that the mobile devices 22 may be any type of device capable of capturing and transmitting A/V files. For example, the mobile device 22 may be a portable camera with a wireless transceiver for communicating with the media center 20.

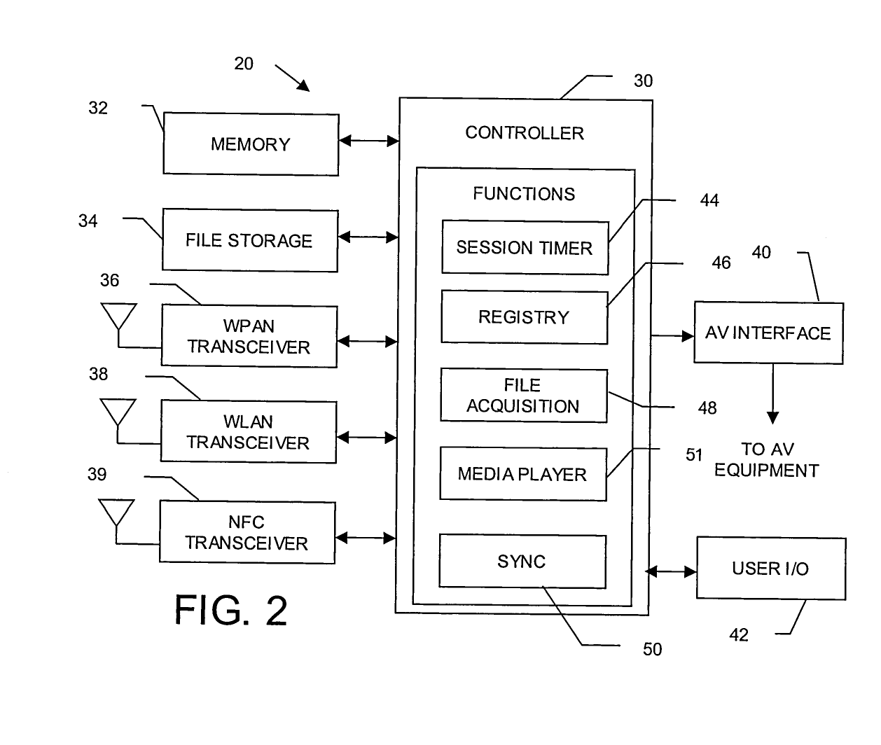

Referring now to FIG. 2, a block diagram of the media center 20 is shown. The media center 20 may be incorporated in a stand-alone device, as part of an existing device such as a personal computer, etc. As will be appreciated, the media center 20 acts as a wireless network access point with which the mobile devices 22 may register.

In the exemplary embodiment, the media center 20 includes a controller 30 incorporating a microprocessor or other central processing unit (not shown). The controller 30 executes application programs designed to carry out the various functions described herein. One having ordinary skill in the art of computer programming will readily appreciate how to program the controller 30 to carry out the various functions described herein without undue effort or experimentation based on the disclosure herein. Accordingly, additional detail has been omitted for sake of brevity.

The media center 20 preferably includes memory 32 having random access memory (RAM) for use as operating memory, as well as read only memory (ROM) for storing the various application programs described herein. In addition, the media center 20 includes a file storage device 34 such as a hard disk drive, etc., for storing A/V files obtained from the various mobile devices 22. Further, the media center 20 includes a wireless personal area network (WPAN) transceiver 36 and/or wireless local area network (WLAN) transceiver 38, for example, to enable wireless communication between the media center and one or more mobile devices 22 in accordance with the present invention. An example of a WPAN transceiver is a conventional Bluetooth transceiver commonly found in mobile devices 22 such as mobile phones. An example of a WLAN is a conventional IEEE 802.11(b) or (g) transceiver as is also commonly found in mobile devices 22. The present invention is not limited to any particular type of WLAN or WPAN as will be appreciated. Additionally, the media center 20 may include a near field communication (NFC) target, reader and/or transceiver 39 which relies on near field coupling to communicate with another NFC device using technology similar to that found in the RFID tags, smart cards, etc. The NFC transceiver 39 may itself be considered a type of WPAN transceiver as will be appreciated.

The media center 20 further includes an A/V interface 40 for connecting the output of the media center 20 to the monitor 26 (FIG. 1) or other A/V reproduction device. Alternatively, the media center 20 may itself be part of an all-in-one type device that includes a built-in monitor, audio reproduction equipment, etc., without departing from the scope of the invention. Still further, the media center 20 preferably includes a user input/output interface 42 such as a keypad and/or display for allowing user control of the media center 20 as described herein.

As previously mentioned, the media center 20 executes various application programs for carrying out various functions described herein in accordance with the invention. These functions include a session timer 44 that allows a user to set a particular time for a file sharing session to occur. For example, suppose a graduation party is scheduled for 8:00 pm to 10:00 pm. The user may enter the starting and ending times for the party via the user I/O 42 so as to define the session. As a result, at 8:00 pm the media center 20 automatically begins to solicit registration of any mobile devices 22 within the network. With respect to any mobile devices 22 which register and submit A/V files between 8:00 pm and 10:00 pm, the media center 20 receives these A/V files and stores them in the file storage 34 and/or reproduces the files via the A/V interface 40, for example. At 10:00 pm or some predetermined time before or after, the media center 20 transmits a request to each of the registered mobile devices 22 requesting whether the mobile devices 22 wish to synchronize themselves with the content of the A/V files received by the media center 20. The media center 20 proceeds to synchronize with those mobile devices 22 desiring synchronization, and thereafter ends the session.

As will be appreciated, the particular manner in which sessions are defined and carried out using the media center 20 is not germane to the present invention in its broadest sense.

The media center 20 includes a registry function 46 responsible for registering and maintaining a list of the various mobile devices 22 electing to participate in a given file sharing session. In addition, the media center 20 includes a file acquisition function 48 for processing the A/V files received from the different mobile devices 22 via the transceiver 36 and/or transceiver 38. For example, the file acquisition function 48 keeps track of which particular A/V files were received from which particular mobile devices 22. As a result, during a synchronization procedure as part of a synchronization function 50 for example, the media center 20 is able to determine which particular files a given mobile device 22 itself provided as compared to which particular files were provided by other mobile devices 22.

Furthermore, the media center 20 includes a media player function 51. The media player function 51 serves to reproduce image files such as jpeg type files, video files such as mpeg type files, audio files such as mp3 files, etc., via the A/V interface 40 or the like. In this manner, the media center 20 may reproduce the files stored in the file storage 34 via the monitor 26 (FIG. 1), for example. The media player function 51 may implement various known fanciful reproduction techniques such as slide show, fade in/out, pan and scan, framing of images, etc.

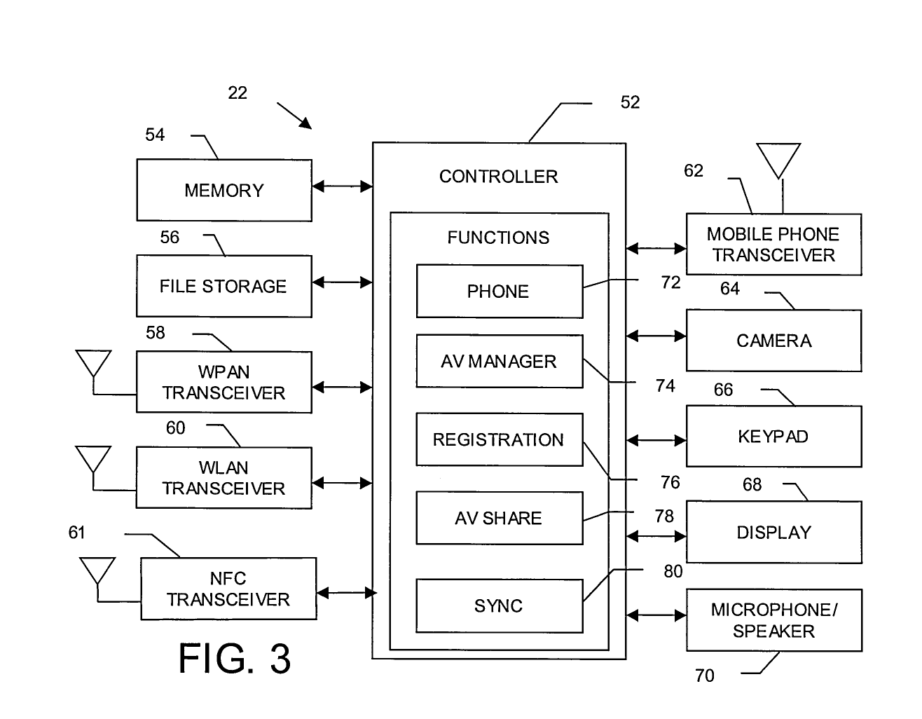

FIG. 3 illustrates an exemplary mobile device 22. The mobile device 22 includes a controller 52 incorporating a microprocessor or other central processing unit (not shown). The controller 52 executes application programs designed to carry out the various functions described herein. One having ordinary skill in the art of computer programming will readily appreciate how to program the controller 52 to carry out the various functions described herein without undue effort or experimentation based on the disclosure herein. Accordingly, additional detail has been omitted for sake of brevity.

The mobile device 22 includes memory 54 having random access memory (RAM) for use as operating memory, as well as read only memory (ROM) for storing the various application programs described herein. The mobile device 22 also includes a non-volatile file storage device 56 such as flash memory, a hard disk drive, etc., for storing A/V files captured by the mobile device 22 itself and/or obtained from the various mobile devices 22 via the media center 20. Similar to the media center 20, the mobile device 22 includes a WPAN transceiver 58 and/or WLAN transceiver 60 compatible with the corresponding WPAN transceiver 36 and/or WLAN transceiver 38 included in the media center 20 so that the mobile device 22 and media center 20 may communicate as described herein. In addition, the mobile device 22 may include an NFC target, reader and/or transceiver 61 which enables the mobile device 22 to communicate with the media center 20 via the NFC transceiver 39.

In the case where the mobile device 22 is a mobile phone, the mobile device 22 includes a mobile phone transceiver 62 for carrying out conventional mobile phone communications. In addition, the mobile device 22 includes a camera 64 that may be used for capturing still and/or video images as is known. Pictures and/or videos obtained by the mobile device 22 via the camera 64 are transmitted automatically to the media center 20 as described herein. The mobile device 22 further includes a keypad 66 and display 68 which allow the user to control various functions of the mobile device 22, to input information such a phone numbers, etc., and to otherwise serve as an interface for the user as is conventional. Moreover, the mobile device 22 includes a microphone/speaker arrangement 70 as is conventional for allowing the mobile device to serve as a mobile phone, media player, etc. Additionally, the microphone 70 may be utilized to capture audio alone or as part of a video segment so as to create corresponding A/V files. Again, such A/V files may then be transmitted automatically to the media center 20 as described herein.

Each mobile device 22 executes various application programs for carrying out various functions described herein in accordance with the invention. These functions include a conventional mobile phone function 72 in the case where the mobile device 22 is a mobile phone. In addition, the mobile device 22 includes an A/V file manager function 74 for managing the A/V files obtained by the mobile device 22. For example, the A/V file manager function 74 may name and store the A/V files in appropriate folders as they are captured as is conventional.

Further, the mobile device 22 includes a registration function 76 for carrying out registration with the media center 20 as described herein. The mobile device 22 also includes an A/V file sharing function 78 for exchanging A/V files with the media center 20 as described herein. Still further, the mobile device 22 includes a synchronization function 80 for synchronizing A/V file content with the media center 20 as is also described herein.

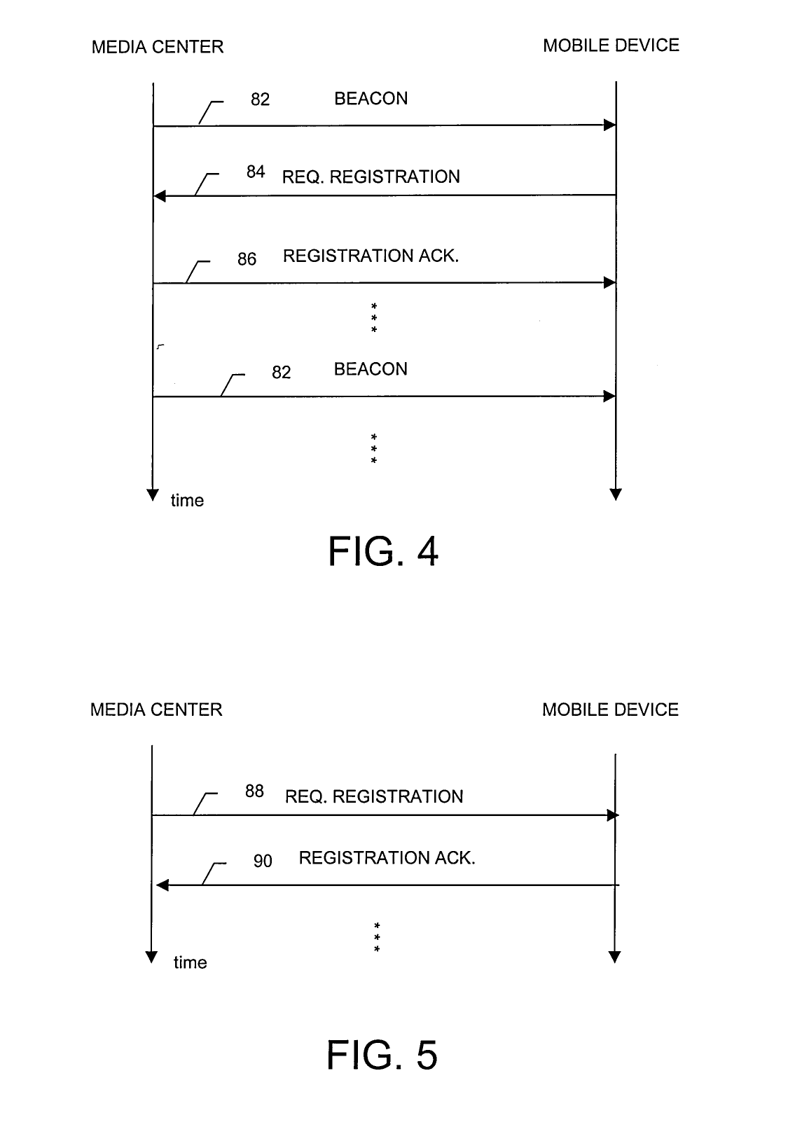

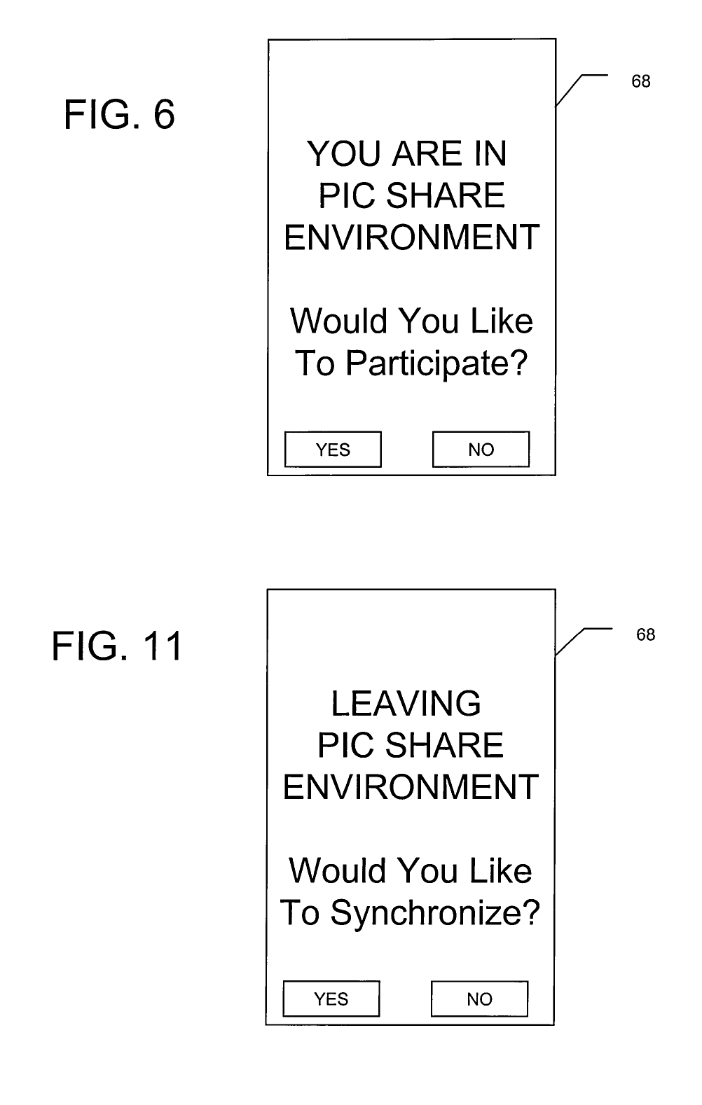

Referring now to FIGS. 4 and 5, two different examples of the automatic registration procedure are shown in accordance with the present invention. FIG. 4 illustrates a procedure in which the registry function 46 of the media center 20 periodically transmits a beacon via the wireless transceiver 36 and/or 38 as represented at 82. The media center 20 may be configured to transmit such beacon whenever the media center 20 is active, or only during such time as a particular session is active. The beacon is configured to identify the presence of the media center 20, and thereby solicit registration of the mobile devices 22. The mobile devices 22 that are within range of the media center 20 will receive the beacon via their transceiver 58 and/or 60. Upon receiving such a beacon, the registration function 76 of the mobile devices 22 is configured to prompt the user of the mobile device 22 regarding the availability of the media center 20. For example, the registration function 76 causes a prompt such as that shown in FIG. 6 to be displayed on the display 68 of the mobile device 22. As is shown, the prompt indicates to the user that the user is in an A/V file (e.g., picture) sharing environment. The prompt asks whether the user would like to participate.

Depending on whether the user of the mobile device 22 wishes to participate, the user responds to the prompt by pressing an appropriate key on the keypad 66 corresponding to yes or no. If the user responds “no”, the registration function 76 of the mobile device 22 makes a record of such so as not to bother the user should a subsequent beacon be received. Conversely, if the user response “yes”, the registration function 76 causes the mobile device 22 to transmit a “registration request” to the media center 20 via the transceiver 58 and/or 60 as represented by 84. Using known access point protocols, for example, the “registration request” is a digital packet that identifies the particular mobile device 22 and indicates a desire to be registered. The registry function 46 of the media center 20 in turn registers the particular mobile device 22 and responds with a “registration acknowledgement” via the transceiver 36 and/or 38 as represented by 86. Thereafter, the mobile device 22 is registered for participation in the A/V file sharing. In the meantime, the media center 20 continues to periodically transmit the beacon 82 in order to register any additional mobile devices 22 that may have come within range.

In an alternate embodiment, the mobile devices 22 request and accept registration, and thereby indicate a desire to participate in the A/V file sharing, via their respective NFC transceiver 61 and the NFC transceiver 39 in the media center 20. Upon receiving a beacon via its transceiver 58 and/or 60 (or even from NFC transceiver 39 via the mobile device's NFC transceiver 61 if within sufficient range), the user of the mobile device 22 may respond to the prompt by bringing the NFC transceiver 61 of the mobile device 22 into close proximity, or “touching” the media center 20, and specifically the NFC transceiver 39 therein in order to enable NFC communication. The mobile device 22 and the media center 20 are configured to thereafter carry out the registration protocol via their respective NFC transceivers.

FIG. 5 represents an alternative registration protocol. Rather than transmit a beacon as in FIG. 4, the registry function 46 of the media center 20 transmits a “registration request” via the transceiver 36 and/or 38, for example, as represented by 88. The “registration request” identifies the existence of the media center 20 and solicits registration of the mobile devices 22 by requesting whether the mobile device wishes to participate in the A/V file sharing. A mobile device 22 that is within range of the media center 20 receives the request and, similar to the procedure described above, prompts the user via the display 68 whether he or she wishes to participate in the file sharing as illustrated in FIG. 6. A mobile device 22 wishing to participate responds with a “registration acknowledgement” as represented by 90. Again, such response may be via the transceiver 58 and/or 60, or via the NFC transceiver 61 by virtue of the user of the mobile device 22 causing the mobile device 22 to “touch” the media center 20. Thereafter, the mobile device 22 is registered for participation in the A/V file sharing. Similar to the above-described beacon, the media center 20 may then periodically transmit requests for registration in order to register any additional mobile devices 22 that may have come within range.

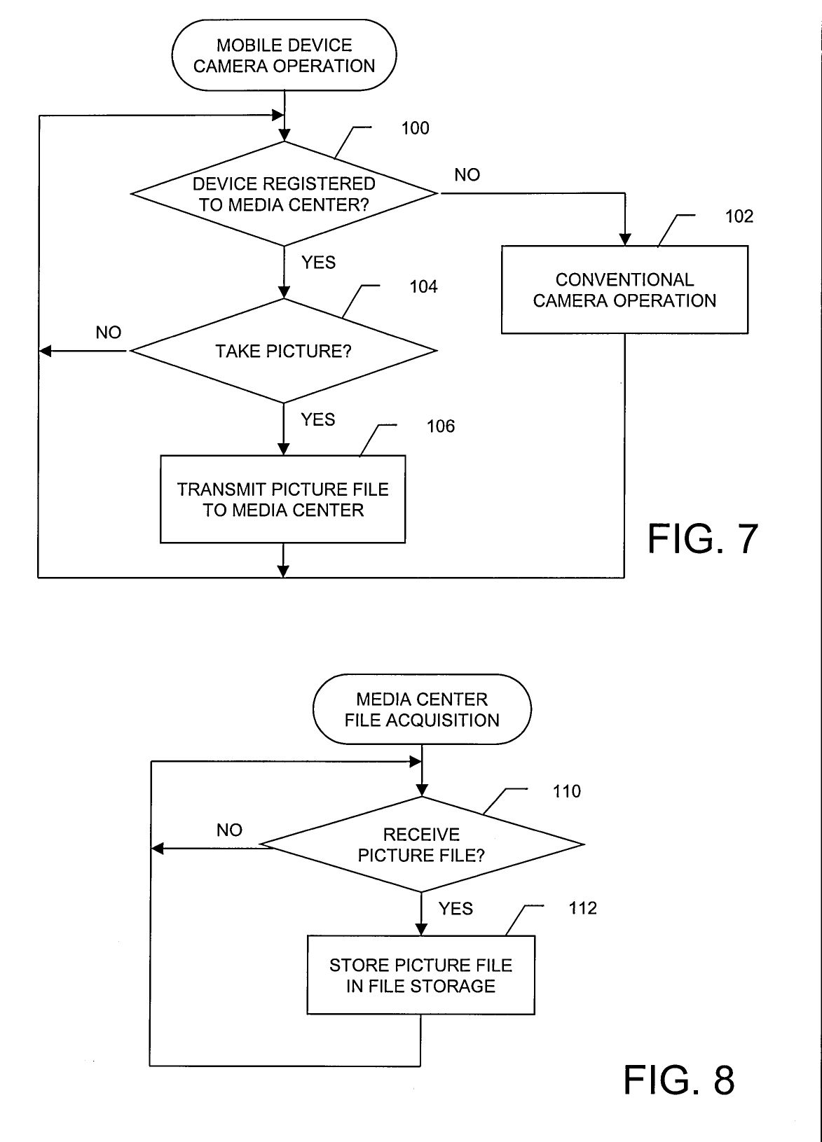

FIG. 7 represents operation of a mobile device 22 in accordance with the present invention. The invention is described with respect to the mobile device 22 being used as a camera to take a still picture which may then be stored as a jpeg file or the like. However, it will be appreciated that the file may be another type of A/V file without departing from the scope of the invention.

Beginning in step 100, the mobile device 22 determines if the device has registered with a media center 20 as described above in relation to FIGS. 4-6, for example. If no, the mobile device 22 operates conventionally as a camera as represented by step 102 and returns to step 100. If the mobile device 22 has registered with the media center 20, the mobile device 22 proceeds to step 104 in which it is determined if the user has taken a picture using the camera 64. For example, the mobile device 22 determines if the user has pressed a key activating a shutter operation on the mobile device 22, causing an image to be captured and stored as a jpeg file in the file storage 56 (FIG. 3). If not, the mobile device 22 continues to loop through step 100.

If the user has taken a picture using the camera 64 as determined in step 104, the mobile device 22 proceeds to step 106 in which the mobile device 22 automatically transmits the jpeg picture file to the media center 20. Specifically, the A/V share function 78 causes the picture file to be packaged in one or more packets that are transmitted digitally via the transceiver 58 and/or 60 to the corresponding transceiver 36 and/or 38 of the media center 20. (Although the corresponding NFC transceivers 39 and 61 could be used to carry out such file transfer, this is least preferred due to the limited bandwidth and range of current NCF technology.) In this manner, the user of the mobile device 22 need not manually initiate the transfer of the A/V file to the media center 20. The transfer is carried out automatically between the mobile device 22 and the media center 20. Thereafter, the mobile device 22 returns to step 100.

FIG. 8 illustrates the corresponding operation of the media center 20 during file sharing. In step 110, the media center 20 determines whether a picture file (or other A/V file) has been received from a mobile device 22 in accordance with step 106 of FIG. 7. If yes, the media center 20 proceeds to step 112 in which the file acquisition function 48 (FIG. 2) stores the received file in the file storage 34. Following step 112, the media center 20 returns to step 110. Similarly, if the media center 20 does not receive an A/V file as determined in step 110, the media center 20 continues to loop through step 110 as represented in FIG. 8.

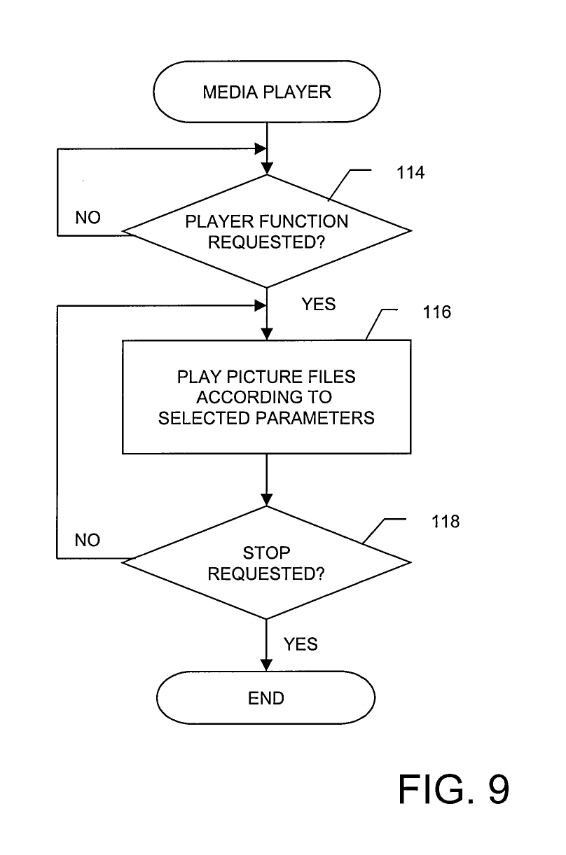

Referring now to FIG. 9, the media player function 51 of the media center 20 is illustrated. Beginning in step 114, the media center 20 determines if a user (e.g., the event host) has requested the media player function. Such request may be via the user I/O 42 (FIG. 2) or any other form of operator input. If no in step 114, the media center 20 simply continues to acquire A/V files from any registered mobile devices 22 while continuing to loop through step 114. If yes in step 114, the media player function 51 proceeds to step 116 and begins to reproduce any A/V files acquired from the mobile devices 22 and stored in the file storage 34. The particular criteria within which the media player function 51 reproduces the files can be based on user selection via the user I/O 42 as will be appreciated. For example, the media player function 51 may be configured to reproduce the A/V files received in a given session in shuffle mode, in order of receipt, etc. Various special effects may be utilized, e.g., fade in/out, pan and scan, etc., when reproducing the files. The media center 20 may be configured to reproduce the A/V files in accordance with a default mode unless otherwise modified by a user, as will be appreciated.

Following step 116, the media center 20 determines in step 118 whether a stopping of the media player function 51 has been requested. Such stop request may be via a user and the user I/O 42, for example. Alternatively, for example, the stop request may be provided by the session timer function 44 indicating the end of a scheduled session.

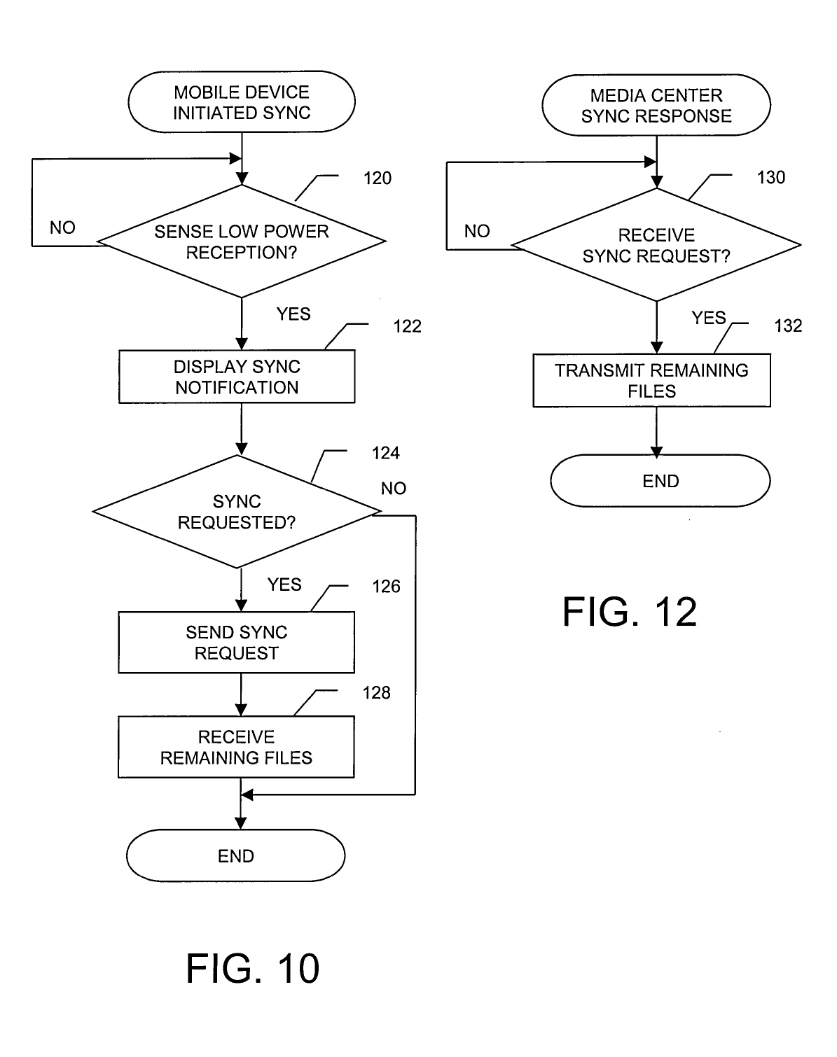

FIGS. 10 and 12 illustrate the operation of a mobile device 22 and the media center 20 in an embodiment in which the mobile device 22 is configured to initiate automatically a synchronization operation. Beginning in step 120, a mobile device 22 belonging to a user who begins to leave the event (e.g., mobile device 22d in FIG. 1) detects such occurrence. For example, the transceiver 58 and/or 60 detects a reduction in power of the signal received from the media center 20 (e.g., the periodic beacons, requests for registration, a signal provided periodically specifically for ascertaining the power level, or any other form of signal transmitted by the media center 20). Upon detecting a received signal level below a predefined threshold, for example, the synchronization function 80 of the mobile device 22 determines that the user is about to leave the event. If the received signal level does not drop below the predefined threshold, the mobile device continues to loop through step 120. The predefined threshold is selected so as to still enable communication between the media center 20 and the mobile device 22, meaning the predefined threshold should not be chosen so as to be too low and thereby prevent subsequent communication.

If in step 120 the mobile device 22 determines that the signal level has dropped below the predefined threshold, the synchronization function 80 in step 122 causes the mobile device 22 to display a synchronization prompt to the user via the display 68 as shown in FIG. 11, for example. In addition, or in the alternative, the mobile device 22 may emit an audible or vibratory warning, for example. As shown in FIG. 11, the prompt is intended to query the user as to whether the user would like to synchronize the mobile device 22 with the media center 20 insofar as the A/V files that have been received by the media center 20. The user may respond via an appropriate function key on the keypad 66, for example. Alternatively, the user may respond by returning to the media center 20 and using the NFC transceiver 61 to “touch” the media center 20 and thereby communicate a request for synchronization.

In step 124, the mobile device 22 determines if the user has requested synchronization. If yes, the mobile device 22 transmits a synchronization request to the media center via the transceiver 58 and/or 60, or via the aforementioned “touching” of the NFC transceivers 39 and 61, as represented in step 126. The media center 20, in turn, is configured to respond by transmitting A/V files stored in the media center 20 to the mobile device 22. The particular A/V files transmitted by the media center 20 are preferably the A/V files acquired from the mobile devices 22 other than the particular mobile device 22 requesting synchronization. The A/V files obtained by the particular mobile device 22 itself presumably are still stored in the mobile device 22. Therefore, the media center 20 need only send the A/V files acquired by the other mobile devices 22. The mobile device 22 receives the files from the media center 20 as represented in step 128. During such time, the mobile device 22 may prompt the user via the display 68 to remain at the event until synchronization has been completed. In this manner, the user of the mobile device 22 leaving the event is able to leave with a collection of the A/V files obtained by all the mobile devices 22 at the event, and all the memories associated therewith.

If, in step 124, the mobile device 22 determines that the user has not requested synchronization, the mobile device simply skips steps 126 and 128 as shown.

FIG. 10 represents a procedure in which synchronization is performed as a result of a mobile device 22 detecting leaving an event. It will be appreciated, however, that synchronization may be carried out simply as a result of the user of a mobile device 22 transmitting a synchronization request at any time by virtue of a user-initiated predefined operation.

FIG. 12 illustrates the operation of the media center 20 in response to a synchronization request from a mobile device 22 as in FIG. 10. Specifically, the synchronization function 50 in step 130 determines if a synchronization request has been received from a mobile device 22 (e.g., via step 126 of FIG. 10). If no, the media center 20 continues to loop around step 130. If yes, the media center 20 proceeds to step 132 in which it transmits the A/V files received from the other mobile devices to the requesting mobile device 22 via the transceiver 36 and/or 38.

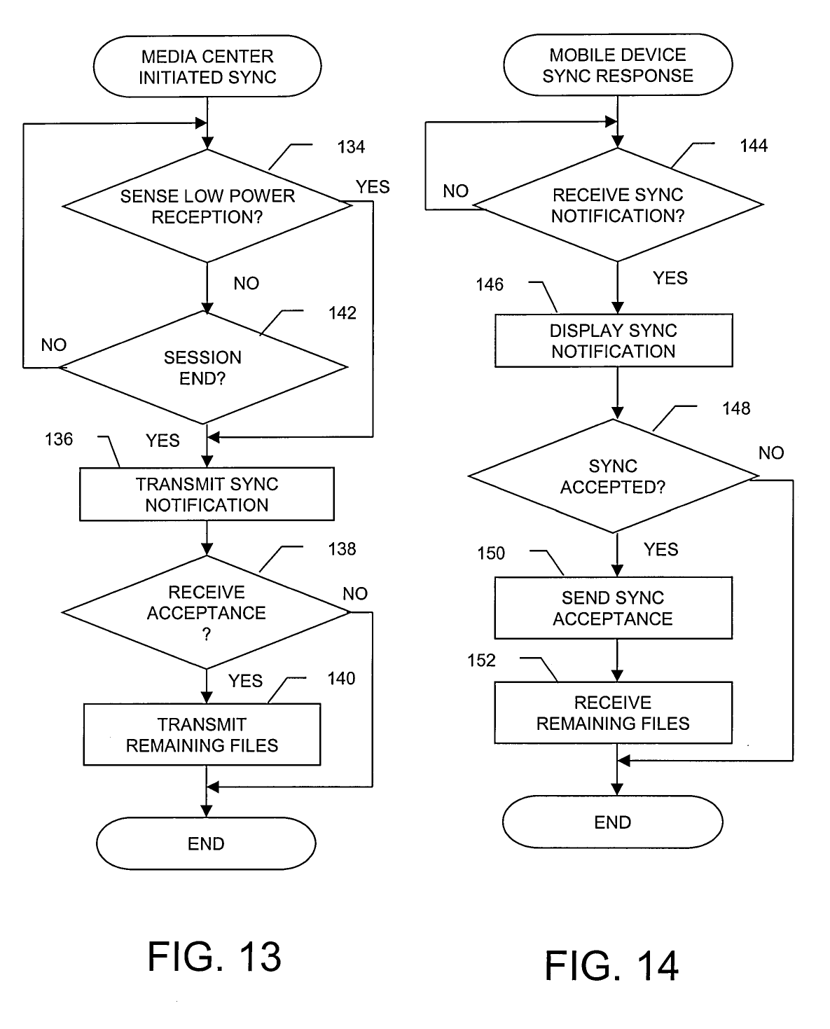

FIGS. 13 and 14 represent an embodiment in which a synchronization operation is initiated by the media center 20. FIG. 13 illustrates the operation of the media center 20. Beginning in step 134, the transceiver 36 and/or 38 of the media center 20 determines if the signal level of the signal received from any particular mobile device 22 drops below a predefined threshold. The signal received from the mobile device 22 may be a signal transmitting an A/V file to the media center 20. Alternatively, the mobile device 22 may be configured to periodically transmit a signal to the media center 20 so that the power level of the received signal may be judged in step 134.

If the signal level from the mobile device 22 is below the predefined threshold as determined in step 134, the media center 20 proceeds to step 136 in which the media center 20 transmits a synchronization notification to the particular mobile device 22 via the transceiver 36 and/or 38. If desiring synchronization, the mobile device 22 is configured to respond to the synchronization request as described with respect to FIG. 14 by transmitting a synchronization acceptance to the media center 20. In step 138, the media center 20 determines in step 138 if a synchronization acceptance has been received from the mobile device 22. If yes, the media center 20 proceeds to step 140 and transmits the A/V files received from the other mobile devices 22 to the particular mobile device 22 requesting synchronization similar to step 132 above. If the particular mobile device 22 does not desire synchronization (e.g., by responding negatively or failing to respond within a predefined time) as determined in step 138, the synchronization step 140 is skipped as shown.

Referring back to step 134, if the media center 20 does not detect a signal level below the predefined threshold the media center 20 proceeds to step 142. In step 142, the media center 20 determines whether the particular session established by the session timer 44 is about to end signaling, for example, the end of the event. If no, the media center 20 continues to loop through steps 134 and 142. If yes, the media center 20 initiates a synchronization operation with all the registered mobile devices 22. Specifically, steps 136, 138 and 140 are carried out with respect to each mobile device 22 so that guests may leave the event with a complete set of the A/V files acquired by the media center 20 should they desire.

FIG. 14 illustrates the operation of a mobile device 22 in response to a synchronization operation initiated by the media center 20. In step 144, the mobile device 22 determines if it has received a synchronization notification via step 136 in FIG. 13. If no, the mobile device 22 continues to loop through step 144. If yes, the mobile device 22 continues to step 146 in which a prompt is displayed to the user similar to step 122 and FIG. 11 as discussed above. Next, in step 148 the mobile device 22 determines if the user selects to accept synchronization via the keypad 66, NFC touching, or the like. If yes, the mobile device 22 is configured to transmit in step 150 a synchronization acceptance to the media center 20 via the transceiver 58 and/or 60, or via the NFC transceiver 61 by “touching” the media center 20, as discussed above in relation to step 138. Next, in step 152 the mobile device 22 receives the A/V files acquired by the media center 20 from the other mobile devices 22 and transmitted by the media center 20 in step 140 as discussed above. If in step 148 the mobile device 22 does not accept synchronization, the mobile device 22 simply skips steps 150 and 152 as shown.

Although not shown, the media center 20 may be connected to a wide area network (WAN) via an internet connection or the like. As a result, users of mobile devices 22 which choose not to synchronize prior to leaving an event may be given the option of obtaining access to the A/V files stored in the media center 20 at a later time via the internet, for example.

Also, during the above described synchronization operation, the media center 20 and/or mobile devices 22 may be configured to prompt the user of a mobile device 22 as to whether the user wishes to obtain low resolution or high resolution A/V files from the media center 20. Low resolution A/V files will speed up the synchronization process as will be appreciated. The user of the mobile device 22 can subsequently obtain high resolution copies of any A/V files via the internet connection as desired.

The invention has been described herein primarily in the context of the media center 20 being a component separate from the mobile devices 22. It will be appreciated, however, that the media center 20 in another embodiment may be incorporated within one of the mobile devices 22 itself.

In still another embodiment of the invention, each mobile device may itself initiate registration and thus participation in the A/V file sharing. Rather than being solicited for registration by the media center 20, the user of a mobile device 22 may rely on the NFC transceiver 61 to initiate and carry out registration with the media center 20 simply by “touching” the NFC transceiver 39. The mobile device 22 and media center 20 are configured to detect the presence of one another and communicate therebetween by virtue of such “touching”, and carry out any suitable registration protocol via the respective NFC transceivers. This avoids the cumbersome procedures associated with prior art devices that require more complex registration procedures by the user.

While the present invention has been described herein in the context of the NFC devices in the mobile devices 22 and the media center 20 being transceivers capable of both transmitting and receiving near field communications, it will be appreciated that the mobile devices 22 and media center 20 may include only a reader or only an NFC tag, depending primarily on the specific communication protocol and whether bidirectional communications are utilized.

Accordingly, it will be appreciated that the present invention provides a media center that is able to store photos and/or videos for an entire event. Moreover, the media center reduces and/or eliminates the burden to a mobile device user in associating the mobile device to the media center and initiating the upload of phones and/or videos, for example. Furthermore, the media center enables the user of a mobile device to obtain easily copies of photos, videos, etc. obtained by guests other than the user.

The term “mobile device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A media center for sharing audio and/or visual (A/V) files among a plurality of mobile devices, comprising:
digital storage for storing A/V files;
a wireless local or personal area network transceiver for receiving A/V files transmitted from the mobile devices and storing the received A/V files in the digital storage; and
a registration section for automatically soliciting registration of mobile devices within the wireless network in order to participate in sharing A/V files.

2. The media center according to claim 1, further comprising an A/V output for providing an A/V output signal suitable for reproducing the A/V files stored in the digital storage.

3. The media center according to claim 1, wherein the registration section is configured to transmit a beacon to the mobile devices via the wireless network transceiver indicating the availability of A/V file sharing.

4. The media center according to claim 3, wherein the registration section is further configured to register individual ones of the mobile devices responding to the beacon in order to participate in the A/V file sharing.

5. The media center according to claim 1, wherein the registration section is configured to transmit a request for registration to the mobile devices in order to participate in A/V file sharing.

6. The media center according to claim 5, wherein the registration section is further configured to register individual ones of the mobile devices responding to the request for registration in order to participate in the A/V file sharing.

7. The media center according to claim 1, further comprising a synchronization section for, during a synchronization operation, transmitting A/V files stored in the digital storage via the wireless transceiver to a given mobile device, the transmitted A/V files including A/V files originally provided to the media center from other of the mobile devices.

8. The media center of claim 7, wherein the synchronization section is configured to keep track of A/V files stored in the digital storage that were provided by a given mobile device, and A/V files stored in the digital storage that were provided from other of the mobile devices, and the synchronization section causes the media center to transmit to the given mobile device substantially only A/V files provided from the other of the mobile devices as a result of the synchronization operation.

9. The media center of claim 7, wherein the synchronization section determines timing of the synchronization operation based on a predefined criteria.

10. The media center of claim 9, wherein the predefined criteria is based on an ending of a predefined session for sharing A/V files.

11. The media center of claim 9, wherein the predefined criteria is based on the media center detecting a mobile device beginning to exceed the range of the wireless network.

12. The media center of claim 9, wherein the predefined criteria is based on the media center receiving a request for synchronization from the given mobile device.

13. A system comprising the media center of claim 1 and at least one mobile device, wherein the mobile device is configured to transmit A/V files automatically to the media center.

14. The system of claim 13, wherein the at least one mobile device comprises a camera, and the mobile device is configured to transmit picture files automatically to the media center upon acquisition by the camera.

15. A mobile device for use with a media center for sharing audio and/or visual (A/V) files among a plurality of mobile devices, the media center including digital storage for storing A/V files; and a wireless local or personal area network transceiver for receiving A/V files transmitted from the mobile device and storing the received A/V files in the digital storage, the mobile device comprising:
an A/V capture device for capturing audio and/or visual and converting the audio and/or visual into A/V files; and
the mobile device being configured to transmit picture files automatically to the media center upon acquisition by the A/V capture device.

16. The mobile device of claim 15, wherein the A/V capture device is a camera.

17. The mobile device of claim 16, wherein the mobile device is a mobile phone.

18. The mobile device of claim 15, further including a synchronization section that determines timing of a synchronization operation, in which the media center transmits A/V files stored in the digital storage via the wireless transceiver to the mobile device, the transmitted A/V files including A/V files originally provided to the media center from other of the mobile devices, based on a predefined criteria.

19. The mobile device of claim 18, wherein the predefined criteria is based on the mobile device detecting it is beginning to exceed the range of the wireless network.

20. The mobile device of claim 9, wherein the predefined criteria is based on the mobile device receiving a request for synchronization from the media center.

21. A media center for sharing audio and/or visual (A/V) files among a plurality of mobile devices, comprising:
digital storage for storing A/V files;
a wireless local or personal area network transceiver for receiving A/V files transmitted from the mobile devices and storing the received A/V files in the digital storage; and
a registration section comprising a near field communication (NFC) device enabling registration of mobile devices within the wireless network in order to participate in sharing A/V files.
